(19) United States
(12) Patent Application Publication
(10) Pub. No.: US 2009/0184883 A1
(43) Pub. Date: Jul. 23, 2009

(54) ANTENNA MODULE AND ANTENNA STRUCTURE THEREOF

(75) Inventor: Ming-Yen Liu, Taipei (TW)

Correspondence Address: QUINTERO LAW OFFICE, PC, 2210 MAIN STREET, SUITE 200, SANTA MONICA, CA, 90405, US

(73) Assignee: ASUSTEK COMPUTER INC., Taipei City (TW)

(21) Appl. No.: 12/349,446

(22) Filed: Jan. 6, 2009

(30) Foreign Application Priority Data
Jan. 22, 2008 (TW) TW97102346

(51) Int. Cl. H01Q 1/38; H01Q 21/00

(52) U.S. Cl. 343/893; 343/700 MS; 343/810

(57) ABSTRACT

An antenna structure includes a first member and a second member. The first member includes a first substrate and at least one radiator formed on the first substrate. The second member is parallel to the first member and is separated from the first member by a distance. The second member includes a second substrate and at least one coupling portion disposed on the second substrate, the coupling portion and the radiator are coupled, and the position of the coupling portion is corresponding to the position of the radiator.

### BACKGROUND OF THE INVENTION

1. Field of the Invention

The invention relates to an antenna structure and, more particularly, to an antenna structure capable of enhancing antenna performance and increasing antenna bandwidth.

2. Description of the Related Art

Along with the development of the wireless transmission technology, portable electronic devices having a wireless communication function, such as mobile phones and personal digital assistants, are gradually popular. To allow the electronic products to be light, slim, short and small, miniature antenna structures such as patch antennas are gradually used in the electronic products.

Although the conventional patch antenna is light and slim, the capacitance of the patch antenna increases, and then the radiating performance is caused to be attenuated. How to increase the antenna gain and the antenna bandwidth is an important subject for designing the antenna structure.

### BRIEF SUMMARY OF THE INVENTION

The invention discloses an antenna structure including a first member and a second member. The first member includes a first substrate and at least one radiator, and the radiator is formed at the first substrate. The second member is parallel to the first member and separated from the first member by a distance, and the second member includes a second substrate and at least one coupling portion disposed at the second substrate. The coupling portion and the radiator are coupled, and the position of the coupling portion is corresponding to the position of the radiator.

In one embodiment of the invention, the projection area of the coupling portion on the first member is greater than or equal to the area of the radiator.

In one embodiment of the invention, the radiator is approximately rectangular and has at least one truncated corner.

In one embodiment of the invention, the first member further includes a grounding layer, and the radiator and the grounding layer are formed at two opposite surfaces of the first substrate.

In one embodiment of the invention, the coupling portion is rectangular.

In one embodiment of the invention, the radiator and the coupling portion are metal conductors.

In one embodiment of the invention, the first substrate and the second substrate are glass-epoxy (FR-4) substrates.

In one embodiment of the invention, the first member further includes a plurality of radiators, and the second member further includes a plurality of coupling portions. Positions of the coupling portions are corresponding to positions of the radiators.

In one embodiment of the invention, the first member further includes a feed-in point, the first substrate has a recess, and the feed-in point is disposed at the recess and electrically connected to the radiators.

In one embodiment of the invention, the first member further includes a group of power dividers formed on the first substrate and electrically connected to the radiators and the feed-in point.

The invention further provides an antenna module including a plurality of antenna structures. The antenna structures are symmetric with respect to a central axis, and the adjacent two antenna structure form an angle. Each of the antenna structures includes a first member and a second member. The first member includes a first substrate and at least one radiator formed on the first substrate. The second member and the first member are parallel and separated by a distance, and the second member includes a second substrate and at least one coupling portion. The coupling portion is disposed at the second substrate, and the coupling portion and the radiator are coupled. The position of the coupling portion is corresponding to the position of the radiator.

### BRIEF DESCRIPTION OF THE SEVERAL VIEWS OF THE DRAWINGS

FIG. 1 is a schematic diagram showing an antenna structure of one embodiment of the invention;

FIG. 2 is a side view showing the antenna structure in FIG. 1;

FIG. 3 is a top view showing the antenna structure in FIG. 1;

FIG. 4 is a schematic diagram showing the first member; and

FIG. 5 is a schematic diagram showing an antenna module of one embodiment of the invention.

### DETAILED DESCRIPTION OF THE EMBODIMENTS

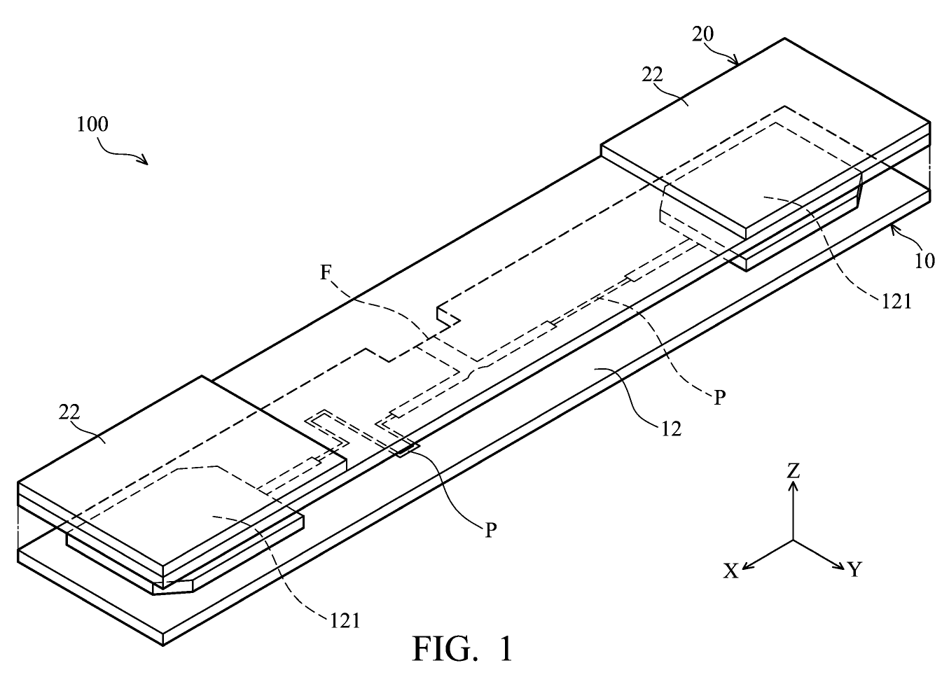

As shown in FIG. 1, an antenna structure 100 of one embodiment of the invention mostly consists of a first member 10 and a second member 20. The first member 10 is, for example, a patch antenna, and includes two radiators 121. Two rectangular coupling portions 22 are disposed on the second member 20, and positions of the coupling portions 22 are corresponding to positions of the radiators 121.

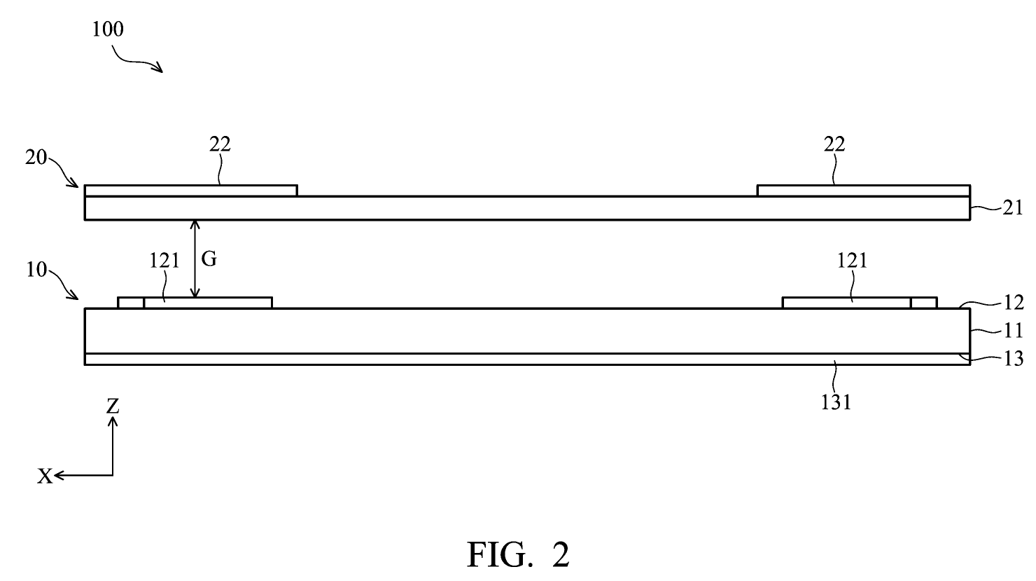

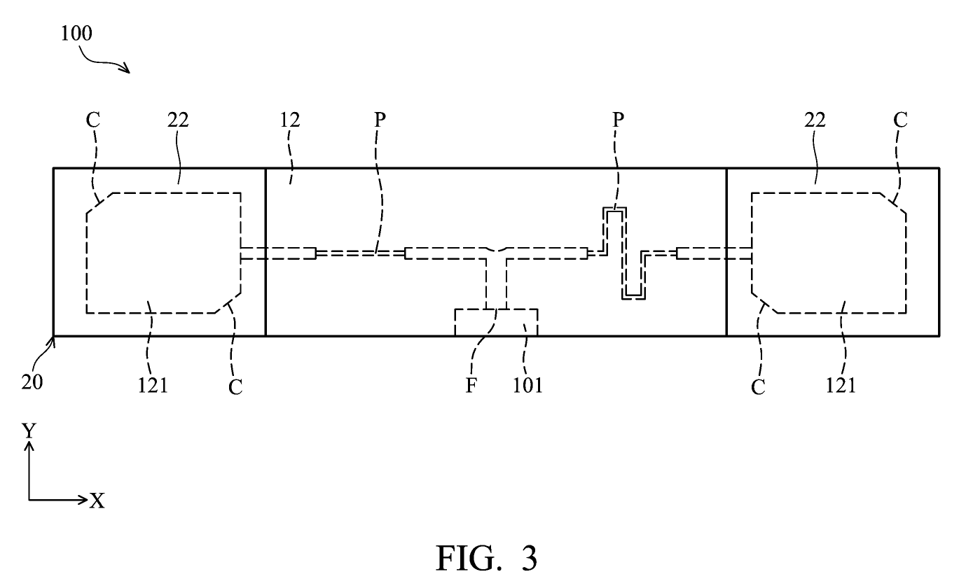

As shown in FIG. 2, the first member 10 and the second member 20 are approximately parallel to each other and are separated by a distance G. The first member 10 has a first substrate 11, the radiator 121 is formed at the upper first surface 12 of the first substrate 11, and a grounding layer 131 is formed at the bottom second surface 13 of the first substrate 11. In the embodiment, the second member 20 has a second substrate 21. The coupling portion 22 is formed on the upper surface of the second substrate 21, and the projection area of the coupling portion 22 on the first surface 12 is greater than or equal to the area of the radiator 121 (as shown in FIG. 2 and FIG. 3).

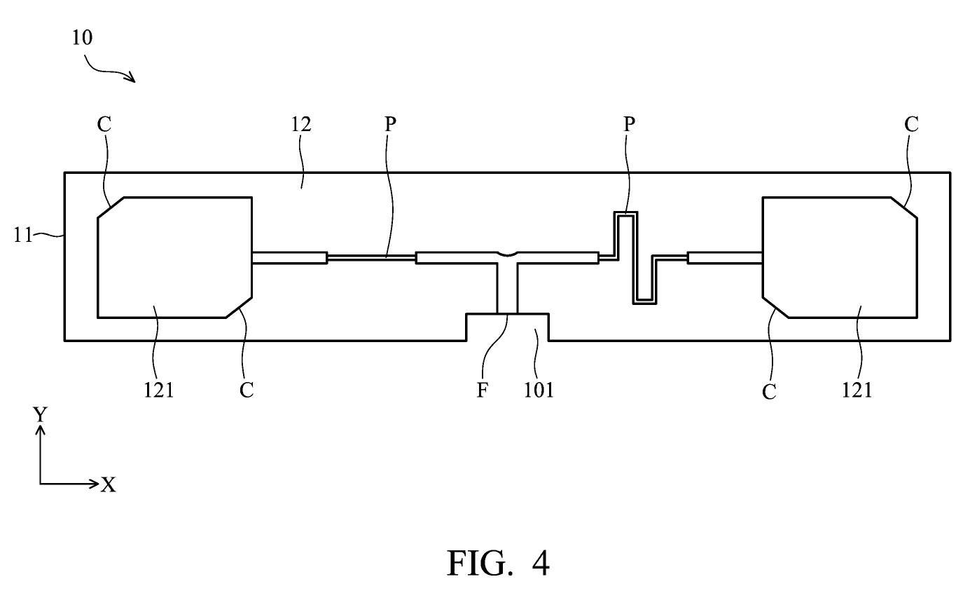

As shown in FIG. 1, FIG. 3 and FIG. 4, a group of power dividers P are disposed on the first surface 12 of the first member 10. The power dividers P are electrically connected to a feed-in point F located at a recess 101 at the middle of the first substrate 11 and the radiators 121 at the two sides of the first substrate 11 to form a patch antenna structure. In the embodiment of the invention, the position of the coupling portion 22 of the second member 20 is corresponding to the position of the radiator 121 of the first member 10, and the coupling portion 22 and the radiator 121 are coupled. Therefore, not only the uni-direction of the antenna is greatly enhanced to greatly increase the gain of the antenna, but also the bandwidth increases to enhance the overall performance of the antenna.

As shown in FIG. 3 and FIG. 4, the radiator 121 is approximately rectangular. The radiator 121 has at least one truncated corner C to increase the gain and the bandwidth of the antenna. In the embodiment, the radiator 121, the grounding layer 131 and the coupling portion 22 are metal conductors. The first substrate 11 and the second substrate 21 are glass-epoxy (FR-4) substrates. The first member 10 also may be provided with one or more than two radiators 121, and the second member 20 is correspondingly provided with one or more than two coupling portions 22. Positions of the coupling portions 22 should be corresponding to positions of the radiators 121, and then the uni-direction of the antenna is enhanced via the mutual coupling between the coupling portions 22 and the radiators 121 further to increase the gain and the bandwidth of the antenna.

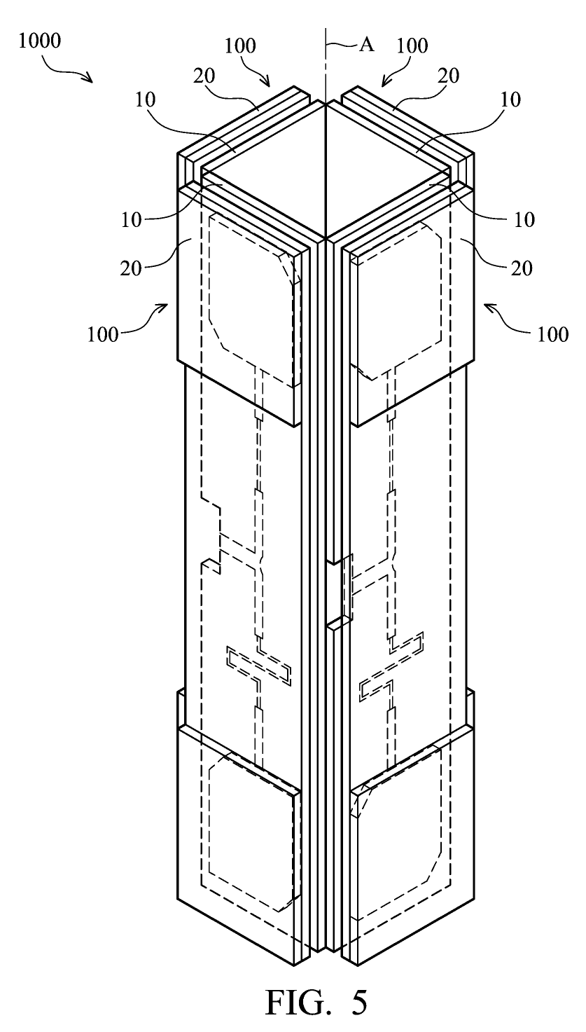

As shown in FIG. 5, in the embodiment of the invention, a plurality of antenna structures 100 may be combined to form a three-dimensional antenna module 1000. The three-dimensional antenna module 1000 of the embodiment consists of four antenna structures 100 that are symmetric with respect to a central axis A. Each of the antenna structures 100 includes the first member 10 and the second member 20. As shown in FIG. 5, two adjacent antenna structures 100 form an angle of ninety degrees to enhance the capability of receiving and transmitting signals in a range of three hundred and sixty degrees further to enhance the overall performance of the antenna.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An antenna structure comprising:
a first member including a first substrate and at least one radiator, wherein the radiator is formed at the first substrate; and
a second member parallel to the first member and separated from the first member by a distance, wherein the second member includes a second substrate and at least one coupling portion disposed at the second substrate, the coupling portion and the radiator are coupled, and the position of the coupling portion is corresponding to the position of the radiator.

2. The antenna structure according to claim 1, wherein the projection area of the coupling portion on the first member is greater than or equal to the area of the radiator.

3. The antenna structure according to claim 1, wherein the radiator is rectangular and has at least one truncated corner.

4. The antenna structure according to claim 1, wherein the first member further comprises a grounding layer, the radiator and the grounding layer are formed at two opposite surfaces of the first substrate, respectively.

5. The antenna structure according to claim 1, wherein the coupling portion is rectangular.

6. The antenna structure according to claim 1, wherein the radiator and the coupling portion are metal conductors.

7. The antenna structure according to claim 1, wherein the first substrate and the second substrate are glass-epoxy (FR-4) substrates.

8. The antenna structure according to claim 1, wherein the first member further comprises a plurality of radiators, the second member further comprises a plurality of coupling portions, and positions of the coupling portions are corresponding to positions of the radiators.

9. The antenna structure according to claim 8, wherein the first member further comprises a feed-in point, the first substrate has a recess, and the feed-in point is disposed at the recess and electrically connected to the radiators.

10. The antenna structure according to claim 9, wherein the first member further comprises a group of power dividers formed on the first substrate and electrically connected to the radiators and the feed-in point.

11. An antenna module comprising:
a plurality of antenna structures symmetric with respect to a central axis, wherein the adjacent antenna structures form an angle, and each of the antenna structures includes:
a first member including a first substrate and at least one radiator, wherein the radiator is formed at the first substrate; and
a second member parallel to the first member and separated from the first member by a distance, wherein the second member includes a second substrate and at least one coupling portion disposed at the second substrate, the coupling portion and the radiator are coupled, and the position of the coupling portion is corresponding to the position of the radiator.

12. The antenna module according to claim 11, wherein the projection area of the coupling portion on the first member is greater than or equal to the area of the radiator.

13. The antenna module according to claim 11, wherein the radiator is rectangular and has at least one truncated corner.

14. The antenna module according to claim 11, wherein the first member further comprises a grounding layer, and the radiator and the grounding layer are formed at two opposite surfaces of the first substrate, respectively.

15. The antenna module according to claim 11, wherein the coupling portion is rectangular.

16. The antenna module according to claim 11, wherein the radiator and the coupling portion are metal conductors.

17. The antenna module according to claim 11, wherein the first substrate and the second substrate are glass-epoxy (FR-4) substrates.

18. The antenna module according to claim 11, wherein the first member further comprises a plurality of radiators, the second member further comprises a plurality of coupling portions, and positions of the coupling portions are corresponding to positions of the radiators.

19. The antenna module according to claim 18, wherein the first member further comprises a feed-in point, the first substrate has a recess, and the feed-in point is disposed at the recess and electrically connected to the radiators.

20. The antenna module according to claim 19, wherein the first member further comprises a group of power dividers formed on the first substrate and electrically connected to the radiators and the feed-in point.
